(19) United States
(12) Patent Application Publication
(10) Pub. No.: US 2001/0053981 A1
(43) Pub. Date: Dec. 20, 2001

(54) System and method for tracking lost articles by means of a global computer network, providing a theft deterrent and advertising

(76) Inventor: Hans Wyssen, Zurich (CH)

Correspondence Address: HANS WYSSEN, SCHAUFELBERGERSTRASSE 18, ZURICH, 8055, CH

(21) Appl. No.: 09/767,832

(22) Filed: Jan. 24, 2001

(30) Foreign Application Priority Data
Jan. 26, 2000 (CA) 2,297,517

(51) Int. Cl. G06F 17/60

(52) U.S. Cl. 705/1; 705/28; 235/375; 235/385; 235/424; 235/442; 235/445; 40/124.01; 705/408; 705/402; 705/26

(57) ABSTRACT

Downloadable identification labels which are downloaded from a world wide computer network to a remote computer and printed on paper using a printer. Each label is printed with the contact information of a central lost and found registry and attached to one or more personal possessions. The labels can also be printed with an identification code, notification that a reward will be paid for a possession which is returned to the owner, sponsor advertising and a warning that the possession has been indelibly marked with identification indicia such as the internet address of the lost and found registry. The central lost and found registry stores, on a database, information about lost possessions and owner contact information as well as information about found possessions and finder's contact information. If a match is found between a lost possession and found possession the registry communicates the contact information of the finder to the owner so that the possession may be recovered by the owner. Owners do not preregister their belongings, codes, or contact information with the central registry. They only register with the registry if a possession should be lost or missing and the owner desires assistance in their recovery.

### FIELD OF THE INVENTION

This invention relates to a method and system for identifying personal possessions and the ownership thereof using a computer network such as the internet as well as providing a theft deterrent and a vehicle for advertising products and services.

### BACKGROUND—FIELD OF INVENTION

The theft or loss of personal possessions, or items, that are unmarked can create difficulties for both the original owners of the items and those who find or recover such items.

In many cases lost or stolen articles, or items, are recovered by police or other public authorities but cannot be returned to the owners of the articles because ownership of the articles cannot be determined. In other words, the personal possessions cannot be accurately identified. The inability to track down the owners of recovered articles results in warehousing and other administrative costs which must be borne by the police or the public authority involved. The owner of the item will often remain unaware that the item has been found and is available to be recovered.

Known in the art are various systems where ID-labels or tags are sold to consumers to attach to their valuables. The ID-labels are printed with the contact information of a central registry such as a telephone number as well as a unique code which the central registry files along with contact information of the owner. If an item is lost, the finder of such an item can contact the central registry and give the central registry the information on the ID-label as well as the contact information of the finder. The central registry then looks up the information it has filed on the unique code and owner information and gives the contact information of the finder to the owner so that the valuable can be recovered.

Their systems suffers from a number of disadvantages:

a) The ID-labels are quite costly since they must be produced with unique codes for each label or user, and are physically sent to consumers using, for example, the postal system which also adds to the expense and is time consuming.

b) Their system requires each individual owner to pre-register their code with a central registry. Anonymity and privacy is therefore sacrificed by creating a database of the owner's names, addresses, codes and property.

c) Their system is expensive to produce and maintain. Vast databases must be constructed and vast amounts of data must be manually entered and updated such as when the owner of the property changes or when the owner's address changes.

d) Do not provide a theft deterrent since the labels are easily removed from property.

### OBJECTS AND ADVANTAGES

Accordingly, several objects and advantages of the present invention are to provide an effective method of identifying personal property for consumers that:

a) Is inexpensive since ID-labels can be distributed to consumers at little or no cost electronically over a computer network such as the internet and do not need to be physically sent to the consumer, thereby also saving time.

b) Provides anonymity and privacy to owners who's property is not lost or stolen since no database pre-registration is required, as is done with prior art systems. The owner can however register with the central registry if property is lost or stolen and help in their recovery is desired.

c) Is inexpensive to maintain since pre-registration of consumers and their ID-codes are not required. Therefore vast databases of information do not have to be maintained and constantly updated when owner addresses or ownership changes, since owners do not need to register with a central registry unless they require aid in recovering a lost or stolen article,

d) To provide a viable theft deterrent to prevent property from being stolen.

A further object and advantage of the present invention is:

To provide for a new vehicle for advertising products and services.

### BRIEF DESCRIPTION

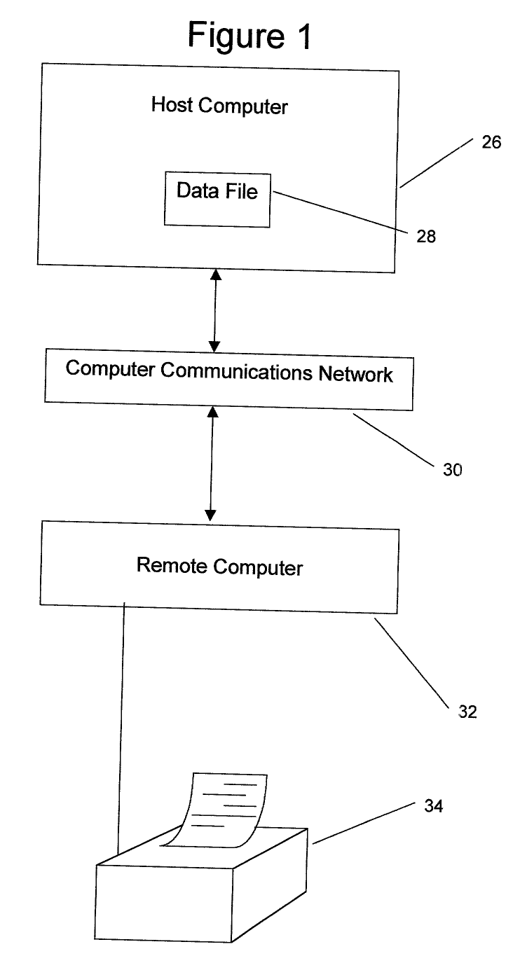

FIG. 1, in a schematic representation, shows the configuration of the system of the preferred embodiment.

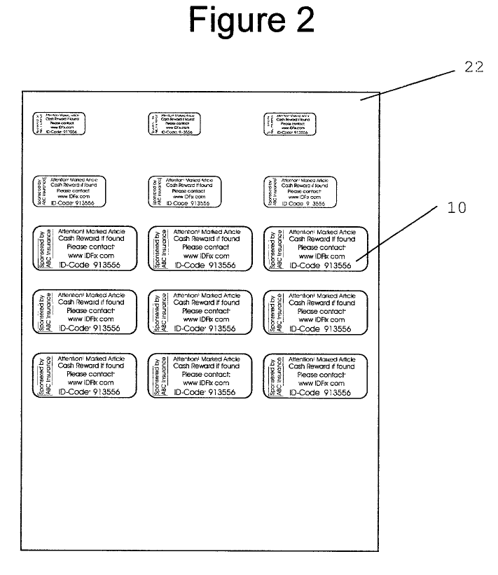

FIG. 2 illustrates a sheet on which ID-labels are printed.

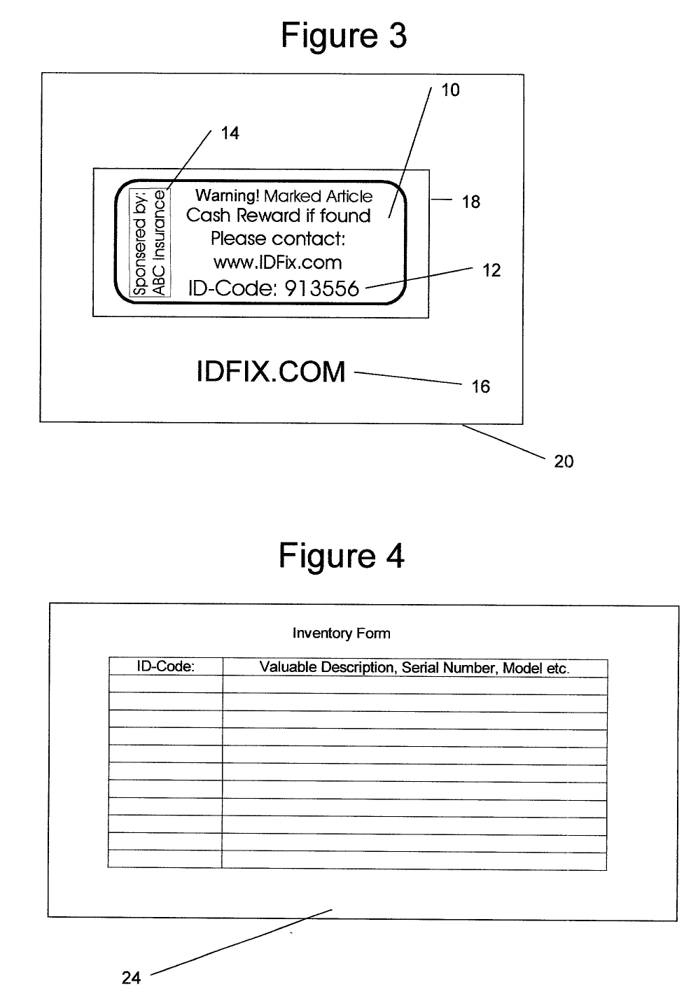

FIG. 3 illustrates an ID-label which has been affixed to the surface of an article.

FIG. 4 illustrates an inventory form.

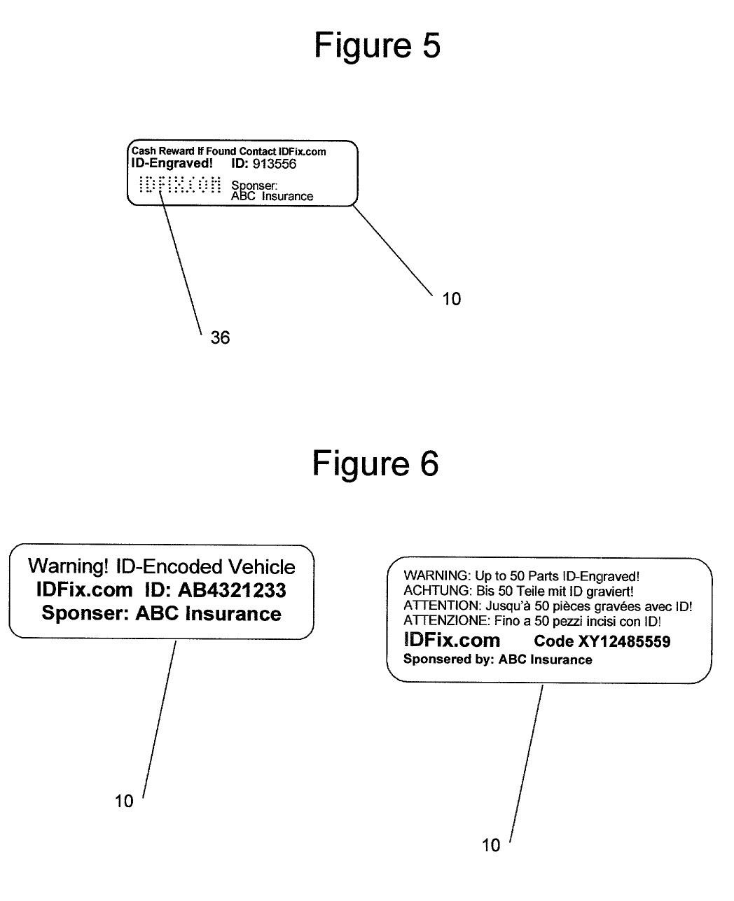

FIG. 5 illustrates an ID-label which includes a stencil pattern for engraving the surface of a valuable.

FIG. 6 illustrates ID-labels which can be affixed to vehicles.

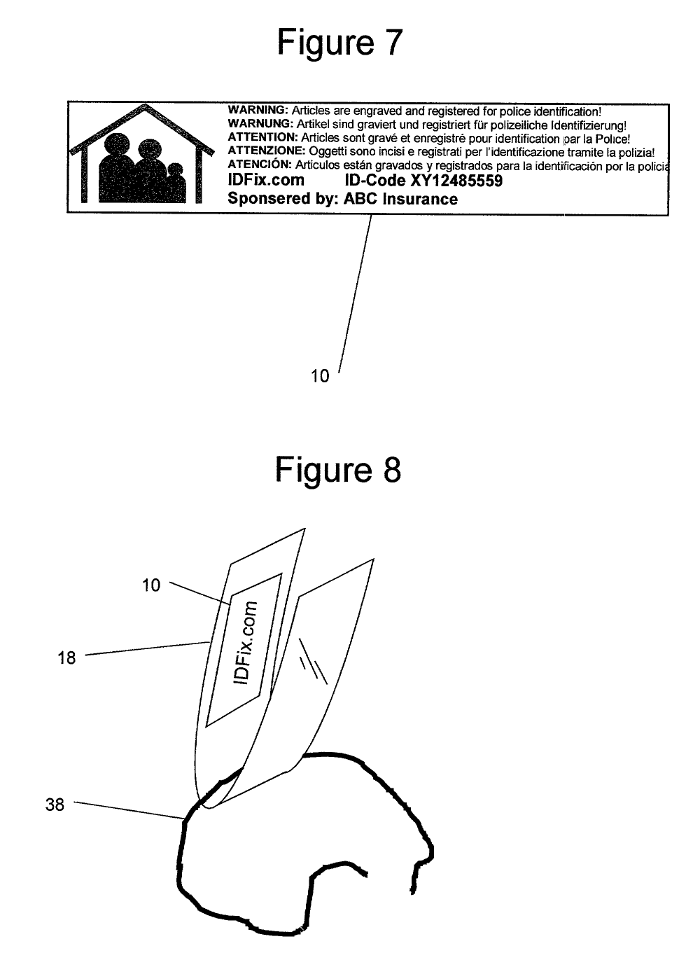

FIG. 7 illustrates an ID-label which can be affixed to a door or window of a building.

FIG. 8 illustrates a method of attaching an ID-label.

### REFERENCE NUMERALS IN DRAWINGS

10 ID-label

12 ID-code

14 Advertising

16 Marking

18 Adhesive Tape

20 Article Surface

22 Sheet Material

24 Inventory Form

26 Host Computer

28 Data File

30 Computer Network

32 Remote Computer

34 Printer

36 Stencil Pattern

38 String

### DESCRIPTION FIGS. 1 to 8

In the preferred embodiment (FIG. 1) a data file 28 stored on a host computer 26 such as a web server is downloaded to a consumer's remote computer 32 through a computer network 30 such as the internet.

In the preferred embodiment of the present invention, data file 28 contains the following digitized material:

1) A plurality of ID-labels 10 (FIGS. 2, 3 & 5, 6, 7) which can be printed out on sheet material 22 (FIG. 2) such as paper by consumers using a printer 34. FIG. 3 shows an ID-label 10 which has been printed on sheet material 22 and has been affixed to an article surface 20 using a piece of transparent adhesive tape 18. An important feature of the present invention is that physical ID-labels 10 or ID-tags are not produced and delivered to consumers, but rather ID-labels 10 are distributed to consumers in digital form, preferably through a computer network such as the internet.

2) An inventory form 24 (FIG. 4) on which the consumer can note details of valuables which have been labeled. FIG. 4 shows an example of inventory form 24 which has been printed on paper.

3) Instructions for printing and applying ID-labels 10 to belongings.

Methods by which consumers may receive data file 28 over the internet include:

1) Consumers visit a web site or internet page using remote computer 32 and download data file 28.

2) Consumers visit an internet site using remote computer 32 and order data file 28 to be sent to them electronically using email.

3) Email marketing may be used to send data file 28 or the internet address from where it can be downloaded to a plurality of consumers.

4) Emails containing data file 28 or a web address from where such can be downloaded may be forwarded from one consumer to another.

Preferable file formats, for data file 28, include formats which can be used on a plurality of computer operating systems. This is preferable, for example, if email marketing is used to distribute data file 28. Preferable formats include the PDF or Portable Document Format from Adobe Acrobat. Adobe Acrobat's PDF format has been found to be advantageous for consumers, since the program for reading this format is offered at no charge by the maker. Email containing data file 28 in PDF format can, for example, be sent to numerous consumers using email, as is known in the art.

While the PDF file format is preferable, data file 28 may be offered to consumers in other file formats as well. Data file 28 in different file formats and versions may be posted for downloading at an internet site so that consumers may download the selected file or files. The selection can, for example, include:

files for use with specific computer software and versions, such as Microsoft Word, Word Perfect, StarOffice, Adobe Acrobat, Microsoft Excel, Microsoft Access, etc. Since most consumers have text editing programs installed on their computers, consumers can, for example, be offered a plurality of downloadable files that have been formatted for processing with specific text editing or reading software and versions.

files for use with software programs running on different computer operating systems such as Microsoft Windows, Apple, Unix, Linux etc.

files formats which can be used with a plurality of software programs such as, for example RTF (Rich Text Format) and graphic formats including: TIFF, GIF and JPEG.

files in a preferred language such as English, French etc.

files formatted for printing on a specific paper size, such as, for example, A4 stock.

files including ID-labels 10 formatted for printing on a specific paper size with pre-cut adhesive labels in a specific size, such as for example, Avery Standard labels.

files with special versions, for example, for companies who have many items to label or private consumers who have fewer items to label.

It is preferable that data file 28 include a plurality of ID-labels 10 in different sizes, shapes and types for attaching to various valuables. Smaller ID-labels 10 for affixing to, for example, keys and larger ID-labels 10 for applying to, for example, laptop computers and bicycles. FIG. 2 shows a plurality of ID-labels 10 which have been printed out on sheet material 22. FIGS. 3, 5, 6 and 7 show examples of ID-labels which may be included in data file 28.

FIG. 3 shows information which can be printed on ID-label 10. In the preferred embodiment of the present invention ID-label 10 is printed with contact information of a central registry or lost and found center. This contact information includes preferably an internet address of the central registry. The contact information of a central registry is more preferable than the address of an owner. For example, if the address of an owner is attached to a key ring it would put the owner at risk since the finder could use the keys in a dishonest way. ID-label 10 is preferably also printed with notification that a reward is offered for the return, to the owner, of the found valuable. It has been found that a finder is more likely to return a found item if a financial reward is offered. A consumer can, if desired, also write on ID-label 10 the amount which would be rewarded if the found item is returned to the owner.

In the preferred embodiment ID-label 10 is also printed with an ID-code 12 (FIG. 3) which helps to identify the owner should the belonging be lost. An important feature of the present invention is that ID-code 12 is not included in data file 28 but added by the consumer. Distributing generic ID-labels 10 to consumers without ID-code 12 has the following advantages:

Is more simple and inexpensive to distribute since the same file with generic ID-labels 10 without ID-codes 12 can be distributed electronically to a plurality of consumers, unlike files which have been uniquely formatted for each consumer with unique ID-codes 12.

Gives consumers more anonymity and privacy since the central registry has no way of knowing which ID-code 12 a consumer adds to ID-label 10. This is in contrast to prior art lost and found systems where all codes are filed along with information about owners and their valuables in a central registry. The anonymity provided for by the present invention is particularly advantageous since computer networks are subject to security breaches. In the preferred embodiment, the central registry will not file all consumer contact information and ID-codes 12 as is done with prior art lost and found systems. In the preferred embodiment it is only in the case that a consumer has a missing valuable and reports this to the central registry, that the registry files the contact information of the owner and information about the lost article including ID-code 12.

ID-code 12 can be alphanumeric being made up of numbers and/or letters and may also include symbols. ID-code 12 is preferably added, by the consumer, to ID-label 10 electronically or digitally, before printing, in the following way:

opening data file 28 with a software program such as, for example, Adobe Acrobat Reader or Microsoft Word and entering ID-code-12 so that when printed out, ID-labels 10 are printed with the desired ID-code 12.

Methods by which ID-code 12 can be added, by consumers, to ID-label 10, after printing, include the following:

Printing out the ID-label 10 and then adding ID-code 12 manually using a writing instrument such as a pen.

The likelihood of two consumers marking the same type of valuable, such as for example, a camera, with the same ID-code 12 and losing it at the same time is extremely unlikely. However to reduce the incidence or likelihood of a plurality of consumers using the same ID-code 12, the central registry may, for example, encourage consumers to use a 7 digit numeric ID-code 12.

In the preferred embodiment of the present invention, consumers use the same ID-code 12 for all ID-labels 10 included in data file 28, however for certain consumers such as, for example, companies it may be desirable to have different ID-codes 12 printed on each ID-label 10.

In the preferred embodiment, data file 28 also contains inventory form 24 (FIG. 4) on which the owner can note one or more of the following:

1) Detailed information about the labeled valuables, including for example, a serial number, model number, amount paid etc.

2) ID-code 12 that the consumer added to ID-label 10 which is attached to the valuable.

In the preferred embodiment of the present invention, the consumer prints out the entire data file 28 including inventory form 24 and fills in the information manually with, for example, a pen. The information may however also be entered digitally using a computer program and stored in data file 28. Storing this information in an electronic format is advantageous since it can be updated easily. The consumer may, for example, store inventory form 24 electronically on a computer network such as the internet so that it is easily accessible to the consumer should it be needed. For example if the consumer was on a trip and a valuable was missing, data on inventory form 24 can be retrieved over the internet. This data would be important in order to register the valuable as missing with the central registry.

In the preferred embodiment of the present invention data file 28 preferably also contains the following instructions:

how to print out and apply ID-labels 10 to valuables.

how to use the lost and found system should a valuable be missing.

Data File 28 may also have certain user interface functions built in which would make it easier for users. These functions depend on the file format and software capabilities of the software programs and versions used for processing and printing data file 28. As mentioned, different versions of data file 28 may be offered to consumers, for downloading over the internet. These user interface functions may, for example, include the following:

a) In the preferred embodiment of the present invention, data file 28 has a form entry field where the consumer enters ID-code 12. When the user prints out data file 28, a plurality of ID-labels 10 are printed, each with the ID-code 12 that was entered in the form field. Text processing programs including Microsoft Word 97 and Adobe Acrobat 4 have form features which allow an entry field to be created within a document and reference fields placed in the document within ID-labels 10 so that when printed, a plurality of ID-labels 10 are printed with the value entered in the entry field.

b) If consumers desire to print out ID-labels 10 with different ID-codes 12, data file 28 may have a form entry field where the consumer enters a number. When the user prints out data file 28, a plurality of ID-labels 10 are printed with different ID-codes 12 based on the value that was entered in the entry field. For example if “1000000” was entered by the consumer in the form entry field, a plurality of ID-labels 10 may be printed with ID-codes 12 in sequential order: 1000000, 1000001, 1000002, 1000003, etc. In another variation, separate entry form fields can be placed in inventory form 24 or within ID-labels 10 so that when opened with a software program, selected ID-codes 12 may be entered in the fields and when printed out, ID-labels 10 are printed with the selected ID-codes 12. Some software programs allow this to be incorporated into their file formats by using form and field functions. These include, for example, Microsoft Word and Adobe Acrobat.

c) Function buttons for performing operations such as printing and navigation.

d) Bookmarks and hyperlinks for navigating within the document.

While document format data files 28 are preferred, other file formats may also be offered to consumers. For example, data file 28 may be a data-base type file or part of an executable software application as shown in the following examples:

a file which can be processed with a program which the user has installed on remote computer 32. For example a Microsoft “MDB” file may be offered to consumers who have Microsoft Access installed on their computer.

a stand alone executable application including an “exe” file which consumers can install on their computers. Such a software application can be made using, for example, the Microsoft Access Developer Kit.

Data-base format files and applications generally can have more powerful user interface features built in than, for example, document type formats. A data-base type file or application can, for example, include:

a table where detailed information about the labeled valuables is entered using easy to use entry forms.

automatically produce ID-codes 12. For example, the consumer can enter a number in a field and each ID-label 10 can be printed with this number as ID-code 12 or a different code can be automatically generated for each ID-label 10 based on the number entered. For example, for each new article entered, the ID-code 12 could be increased by 1. Of course other mathematical formulas may also be used.

include easy to use buttons for opening entry forms and for printing ID-labels 10.

include various print options for printing different ID-labels 10.

include detailed instructions on using the lost and found system.

Similar functions may also be built into other file formats that can be used with text programs such as, for example, Microsoft Word or spread sheet programs such as, for example, Microsoft Excel.

Interactive web or internet sites may also incorporate similar functions, for example, allowing consumers to enter ID-code 12 and print ID-labels 10 on a printer while logged onto an interactive web site, or download a data file 28 formatted with the ID-codes 12 that were entered by the consumer at the web site.

It is preferred that data file 28 is protected by a password so that consumers may not modify the file in any way other than adding data in the allowed fields. For example programs such as Adobe Acrobat and Microsoft Word allow for the creation of form documents with form fields, which can be protected from being modified with passwords.

While in the preferred embodiment consumers receive data file 28 containing ID-labels 10 via downloading from a computer network such as the internet, consumers may also be given data file 28 on data medium such as diskettes, CD's and the like. For example, magazines often include CD's and could include data file 28.

An important feature of the present invention is it's value as an advertising vehicle for products and services. Data File 28 can contain advertising 14 throughout the document including on the digitized ID-labels 10 as shown in FIG. 3 and also on inventory form 24 and instructions. Advertising 14 may be in the form of graphical and textual information, including for example, the graphic logo of the sponsoring company. Depending on the file format of data file 28, multimedia advertising may also be incorporated which includes sound and video. Advertising 14 may also be incorporated into the internet site of the central registry and/or where consumers download data file 28.

FIG. 3 shows ID-label 10 printed with advertising 14 from a sponsor company. Such advertising can be very valuable since ID-labels 10 are often attached to portable valuables which consumers handle often, such as portable computers and key chains. The presence of advertising 14 can also give more credibility to the lost and found system and convince the finder that a reward will indeed be paid when returning the valuable to the owner.

Advertising 14 can be sold to advertisers thereby generating revenue for the central registry or given free of charge in exchange for distributing data file 28 to consumers. For example, an advertiser can be provided with data file 28 formatted with advertising 14 on ID-labels 10 and throughout the document. The advertiser can then, for example, send data file 28 to its customers via email and/or invite its customers to download data file 28 from a web site.

The central registry may allow an advertiser to distribute data file 28 for an agreed time period or number of downloads from an internet site. Data file 28 may contain a notice that the document is only valid until a certain expiry date. Data file 28 may also be encoded with protection that would, for example, not allow it to be printed out or opened after the expiry date.

Advertising 14 on data file 28 can depend on from where the consumer downloads the file. For example, specific advertising 14 can be directed to consumers in certain geographic locations. For example a consumer from Canada may be instructed to download data file 28 from a certain internet page, where data file 28 contains advertising 14 from a Canadian company. A consumer from France may be instructed to download data file 28 from another web page where data file 28 contains advertising from a company in France.

Such targeted advertising 14 may also depend on other consumer criteria such as age, sex, income etc. For example, if consumers fill in an online form to have data file 28 sent to them via email, such files may contain specific advertising 24 targeted for a particular consumer or group.

More information regarding the advertising value and methods of the present invention will become evident through a consideration of the following examples.

### EXAMPLE 1

An advertiser who is a magazine publisher, publishes a special offer in their magazine. Their readers are notified that they can visit the publisher's internet site and download a free lost and found system in the form of data file 28. When readers open the internet address with their internet browser they download data file 28 in the desired format. The digitized ID-labels 10 as well as other information in data file 28 contain advertising 14 for the magazine publisher whereby the advertiser is named as a sponsor for the free lost and found system. It is to be noted that, if the magazine issue included a CD, data file 28 may be included on the CD.

### EXAMPLE 2

The ABC Insurance company informs it's customers that they can download a free lost and found system at an internet site. At the internet web page, data file 28 is available for downloading in a plurality of formats and contains ID-labels 10 that contain the following message: “Sponsor: ABC Insurance”. ABC Insurance also informs it's customers that they will pay the reward that users post for finding a missing valuable as long as the user is insured with ABC Insurance and the reward does not exceed $50.00.

### EXAMPLE 3

The World Travel Company gives their customers a diskette storing data file 28 in a variety of data formats containing their advertising 14. These include, PDF and Microsoft Word formats. It also informs customers that they can download data file 28 from their web site.

In order to help keep track of data files 28, with different versions, formats and advertisers, it is preferable that the central registry give each data file 28 a serial number. It is also preferable that ID-code 12 be preformatted with a prefix which relates to the serial number. For example if ID-label 10 was preformatted with the alphabetic prefix “RT” and a consumer entered a 7 digit numeric code, ID-code 12 may for example be: RT1234567. Preformatting ID-code 12 with prefixes further reduces the incidence of consumers using duplicate ID-codes 12.

While in the preferred embodiment of the present invention the consumer generates ID-code 12, the central registry can also give consumers the option of receiving an ID-code 12 which is generated by the central registry. Consumers can, for example, receive ID-codes 12 generated by the central registry in the following ways:

after receiving or downloading data-file 28 containing ID-labels 10, consumers may visit the internet site of the central registry and be issued an ID-code 12 which the consumer can enter on ID-labels 10.

A consumer may receive ID-code 12 via email from the central registry by entering an email address at the internet site of the central registry.

A consumer may visit an internet site and interactively, while connected to the internet, print out ID-labels 10 printed with an ID-code 12 generated by the central registry.

A consumer may visit the internet site of the central registry and download data file 28 which contains in digital form ID-labels 10 which are formatted with ID-codes 12 generated by the central registry. Consumers may also order that such a formatted data file 28 be emailed to them by, for example, visiting the internet site of the central registry and leaving their email address.

### Operation (FIGS. 1-8)

In the preferred embodiment of the present invention (FIG. 1) a consumer connects remote computer 32 to a global computer network such as the internet and downloads data file 28, in the selected format, which includes, in digital form, a plurality of ID-labels 10 (FIG. 2) and preferably also instructions and inventory form 24 (FIG. 4). It is preferable that data file 28 is made available free of charge to consumers.

The downloaded data file 28 is either stored on a data medium such as a hard drive on remote computer 32 or only in temporary memory such as RAM of remote computer 32 such as, for example, when data file 28 is opened with Adobe Acrobat Reader within an internet browser.

When data file 28 is opened with software such as, for example, Adobe Acrobat reader or Microsoft Word, the user enters ID-code 12 into an entry field. Data file 28 is printed out on sheet material 22 (FIG. 2), which is paper, using printer 34 which can be, for example, a laser or inkjet printer as is known in the art. In the preferable embodiment of the present invention, all ID-labels 10 which are included in data file 28, are printed out with the same ID-code 12 which was entered into the entry field.

In the preferred embodiment of the present invention data file 28 contains a plurality of ID-labels 10 including various types and sizes, examples of which are shown in FIGS. 3, 5, 6, & 7.

After being cut out from paper sheet material 22 using, for example, a pair of scissors, printed ID-labels 10 can be affixed or attached to most articles using the following methods:

Method 1

Method 1 is the preferred method for most articles. ID-label 10 is affixed to article surface 20 using a piece of transparent adhesive tape 18 as shown in FIG. 3, so that the printed information on ID-label 10 is visible through adhesive tape 18. Adhesive tape 18 is preferably larger than ID-label 10 so that it overlaps ID-label 10 on all sides. For example, a piece of standard 19 mm wide adhesive tape 18 may be used to affix 15 mm wide ID-labels 10 to articles. Tape 18 also makes ID-label 10 more durable. Since most consumers possess transparent adhesive tape with a standard width of about 19 mm it is preferable to include ID-labels 10 in data file 28 which are formatted to have a width which is less than 19 mm when printed out. For wider ID-labels 10, transparent adhesive tape 18 in wider sizes are readily available, such as for example 48 mm packaging tape. Most stationary or office supply stores stock suitable adhesive tape 18 rolls in a plurality of widths. It is preferable that ID-label 10 is affixed to a surface of the valuable which is easily visible. Small sized ID-label 10 can be affixed using adhesive tape 18 to, for example, the collar tag of pets or leg band on birds. They can also be affixed directly onto keys, watch backs and clasps, credit cards etc. Larger ID-labels 10 may, for example, be affixed to computers and bicycles in the same way. When affixing ID-label 10 to windows such as on vehicles and buildings, it is preferable to affix the label to the interior side of the window, with adhesive tape 18 so that the printed information is visible through the window from the outside.

Method 2

Items such as wallets and purses can have ID-labels 10 inserted into folds with no adhesive tape 18. It has been found that a preferred size for such labels is the size of a credit card or about 54 mm by 86 mm, since wallets and purses often have special folds for this size. It is preferable that data file 28 include ID-labels 10 that are formatted so that when they are printed out, produce ID-labels 10 of credit card size. ID-labels 10 with no adhesive tape 18 may also be inserted into ID-tags such as luggage tags and key ring tags. ID-labels 10 may be laminated by affixing adhesive tape 18 to each side. The pieces of adhesive tape 18 should overlap ID-label 10 on all sides. Such laminated ID-labels 10 are more durable and resistant to moisture.

Method 3

FIG. 8 illustrates another method of attaching ID-label 10 to articles. Tape 18 is used to laminate ID-label 10 on both sides with a piece of string 38 inserted at the fold. ID-label 10 can then be attached to suitcase handles, key rings etc, by tying string 38.

While it is preferable that ID-labels 10 are printed out on sheet material 22 which is ordinary paper, since this is widely available to consumers, ID-labels 10 can also be printed out on other materials which are also readily available at office supply stores. These include:

specially coated paper and plastic sheets which are available in a wide variety of colors, including transparent, for most printers. These sheets are often more resistant to wear and tear than ordinary paper and will not yellow with age.

plastic or paper sheet material which has a pressure sensitive adhesive coating on the back side.

sheets with precut labels, such as for example, AVERY standard sizes with adhesive backing which are available in a wide variety of materials, shapes, colors and sizes in many office supply stores. Versions of data file 28 with ID-labels 10 pre-formatted for printing on various label sizes may be offered to consumers.

The consumer can also print out ID-labels 10 on sheets of paper or plastic with no adhesive coating and then apply an adhesive to the back of the label and then affix the label to article surface 22. Even if ID-label 10 is affixed to article surface 20 with adhesive, it is preferable that it is covered with adhesive tape 18 in order to make ID-label 10 more durable.

In order to act as a theft deterrent, article surface 22 may be substantially indelibly marked, in one or more places, with marking 16 (FIG. 3) which preferably includes the contact information of the central registry and is preferably the internet address of the central registry. It is known that often thieves do not steal indelibly marked articles, since it reduces the resale value of stolen goods and makes them harder to sell. Marking 16 also makes it possible for lost articles to be recovered by the owner even if ID-label 10 is removed from the valuable. In order to produce marking 16 the consumer may use, for example, a permanent ink marking pen, hard metal tipped scribe or electric hand engraver. Other methods that may be used include:

acid engraving of glass surfaces or metal surfaces using perforated stencils.

sand blasting through a perforated stencil

stamping tools which impress a mark into surfaces with heat and/or pressure.

permanent ink containing solvents in which article surface 20 is solvent. These inks may be applied using, for example, a perforated stencil or transfer/decal type systems as are known in the art.

marking with a pen containing invisible ink which fluoresces when exposed to UV light.

If article surface 20 is marked, it is preferable that this is noted on ID-label 10 with a message such as for example: “Warning Marked Article”, as shown in FIG. 3. Such a warning message on ID-label 10 serves to help deter theft. FIGS. 5, 6 and 7 show further examples of ID-labels 10 which include a warning message that the valuable has been marked with marking 16. Data file 28 may include ID-labels 10 which are formatted with such warning messages, as well as others which do not include this message, should the consumer not wish to mark the valuable indelibly with marking 16.

FIG. 5 shows an example of ID-label 10 which has been printed with a stencil pattern 36 to facilitate consumers marking article surface 20 with marking 16. After applying ID-label 10 to article surface 20 using, for example, the aforementioned method 1, the owner can use a sharp pointed tool such as, for example, a pin or scribe to perforate stencil pattern 36 at the points thereby engraving article surface 20 with marking 16. This has been found to work well on plastic and painted surfaces, producing a discrete, ascetically acceptable mark. This has been found to work well on valuables such as, for example, cameras and portable computers.

FIG. 6 shows two examples of ID-label 10 which can be used on vehicles such as cars, motorcycles and all terrain vehicles (ATV's). An electric hand engraver or scribe can be used to engrave a plurality of plastic and metal parts of the vehicle such as, for example, motor parts, wheel rims, etc. with marking 16. On vehicles such as cars, two ID-labels 10 may be affixed to the inside of the two front side windows using adhesive tape 18, so that ID-label 10 and it's warning message, can be read from outside of the vehicle. On motorcycles and recreational vehicles one or two ID-labels 10 may be affixed to a visible part of the vehicle such as the front or the sides.

FIG. 7 shows an example of ID-label 10 that may be used to protect buildings such as houses which have valuables which have been marked with marking 16. This ID-label 10 may, for example, be affixed to doors and windows so that they can be read from the outside of the building. Special versions of this ID-label 10 for business premises may also be included in data file 28.

Should a valuable be missing, the owner can contact the central registry and report the missing valuable. In the preferred embodiment, the owner contacts the internet web page of the central registry and fills out an online form giving as much as possible of the following information to the central registry:

Contact information of the owner including email address.

Location and time that the valuable went missing.

Detailed information about the valuable including, manufacturer, serial number, model number etc.

ID-code 12 on ID-label 10.

The consumer can refer to inventory form 24 to obtain some of this information.

In the preferred embodiment, the owner also posts a reward for the return of the valuable. In the preferred embodiment, if the valuable is found, a portion of the reward goes to the finder and a portion to the central registry. For example, 50% of the reward may go to the finder and 50% to the central registry.

The reward posted by the owner, can reflect the value that the owner places on the valuable and not only it's replacement value. For example, the valuable may have great sentimental value as in the case of a family heirloom or pet, or perhaps an electronic device such as a pocket computer contains important data. In many cases, an owner can determine a reward as a percentage of the value of the article. For example 10%. The central registry can also fix a minimum reward requirement in order to cover its basic administration costs and also to insure that a finder receives a respectable reward. The minimal reward requirement set by the central registry may be a fixed amount or may be based on a percentage of the value or replacement cost of the lost belonging. In some cases the owner will be reimbursed the entire or part of the reward by the owner's insurance company.

Should someone find the missing valuable and see the contact information of the central registry on marking 16 or ID-label 10 the finder can contact the central registry. Even if ID-label 10, is no longer on the valuable, the central registry can still be contacted if the valuable was marked with marking 16, which in the preferred embodiment is the internet address of the central registry. In the preferred embodiment, the finder contacts the internet web page of the central registry and fills out an online form giving as much as possible of the following information to the central registry:

Contact information of the finder including an email address.

Location and time that the valuable was found.

Detailed information about the valuable including, manufacturer, serial number, model number etc.

ID-code 12 on ID-label 10.

The central registry regularly checks it's list of missing articles and list of found articles for matches. For a match to be detected, it is preferable that a plurality of matching points be detected, between the lost report and found report filed in the data base of the central registry. The more matching points, the stronger the match. For example:

type of article (camera, bicycle etc) and ID-code 12 on ID-label 110 etc.

If a match is detected between an article reported as missing and an article reported as found, the central registry contacts the owner and gives the owner the finder information so that the missing article can be recovered by the owner. Under no circumstances, in the preferred embodiment of the present invention, would the central registry give the finder the owner contact information.

Before giving the owner the finder information, the central registry may require further information from the owner in order to be sure:

That the person purporting to be the owner is the rightful owner,

That a found article is indeed the missing article, particularly if the match between the missing report and found report is weak.

This information may include:

Proof of purchase, such as a sales receipt or more details about the lost article or where and when it went missing etc.

Preferably before the finder information is provided to the owner by the central registry, the central registry will collect a fee from the owner which in the preferred embodiment is a portion of the finder reward posted by the owner.

It is preferable that the central registry collects the fee from the owner using electronic means such as a credit card or debit card, since this greatly speeds up the recovery process and makes the system more efficient.

Depending on the electronic payment means available, the central registry may collect the entire reward posted by the owner using an electronic payment system and credit electronically the account of the finder after the valuable has been recovered by the owner. However in most cases, the central registry will collect only it's fee or portion of the reward, and the finder will collect the finder's portion of the reward when the owner recovers the missing article.

If the retrieved valuable is damaged or in an unacceptable condition, part or all of the fee collected by the central registry will be refunded to the owner.

Further information about the present invention will become apparent by considering the following example:

### EXAMPLE

A consumer reads in a local newspaper of an internet site where a lost and found system can be downloaded for free. The consumer visits the advertised internet page and chooses from a number of data formats and versions, data file 28 in the Adobe PDF format in the English language. After downloading, the consumer opens data file 28 using the Adobe Acrobat Reader and enters 1234567 as the ID-code 12 in the form entry field. The consumer then prints out the entire data file 28 including ID-labels 10, inventory form 24, and instructions on normal paper. All ID-labels 10 have been printed with ID-code 12 as the number:1234567, which was entered in the entry field. ID-code 12 is also printed on inventory form 24. After cutting out ID-labels 10, the consumer attaches selected ID-labels 10 to various belongings using standard 19 mm wide adhesive tape, following the instructions that were included in data file 28. The owner also fills in the paper printout of inventory form 24 which was included in data file 28. Using a pen the consumer notes the model and serial number of a Minolta camera that was labeled as follows: Dynax 505 si, Ser. No. 95807070. While the consumer is on vacation in London, England, the Minolta camera goes missing and the owner visits a location which offers internet access such as an internet cafe. The owner opens the internet site of the central registry using an internet browser and fills in an online form posting a reward of $80.00 and giving details of the camera including the serial number, ID-code 12 and where it was lost as well as the owner's email address. This information is filed by the central registry. Later, a finder finds the camera and notices ID-label 10 promising a reward and contacts the central registry at it's internet site, filling in an online form including the serial number of the camera, where it was found, and ID-code 12 which is the number 1234567 as well as contact information including an email address. The central registry detects a strong match between the camera that was reported as found and the camera reported as missing. The central registry notifies the owner via email that after payment of $40.00 or 50% of the reward that the owner posted, it will immediately email the finder information to the owner. The owner pays $40.00 to the central registry online using a credit card. Upon receiving payment, the central registry emails the complete finder information to the owner. The central registry also notifies the finder via email that the finder information has been sent to the owner and that the owner will be contacting the finder shortly and will pay the finder the remainder of the reward or $40.00 when recovering the valuable. The owner contacts the finder and arranges to pick up the camera and on finding the camera in good condition pays the finder a $40.00 reward in cash. The insurance company of the owner refunds the owner the $80.00 which was posted as reward.

It is to be noted that in the case of a missing article, many or even all of the aforementioned interactions between the owner, central registry and finder can be automated or interactively integrated into a computer network, web or internet site. This is particularly the case when there is a strong match detected by the central registry between the found report and the missing report, based on a plurality of matching data points such as ID-code 12, serial number etc. More human intervention however is preferable when ID-label 10 is missing and there is only marking 16 on a found valuable with no serial numbers and matches between lost and found articles must be based on for example, descriptions of the article, where and when it was lost etc.

In case of change of ownership of an article, ID-label 10 should be removed from the article.

While in the preferred embodiment consumers add ID-code 12 to all ID-labels 10, it is to be noted that, in most cases, this system will still function, particularly if the article has identifying features, even if for example:

there is no ID-code 12 on ID-label 10.

ID-label 10 is removed from the valuable and marking 16 consisting of the internet address of the central registry is present.

A finder only has to contact the lost and found center or central registry using the internet address on ID-label 10 or marking 16 and provide identifying features of the article, where it was found etc. However the presence of ID-code 12 on ID-label 10 does make the system work more efficiently and is especially important for articles with few distinguishing features such as keys. Corresponding ID-codes 12 on an article reported as found and an article reported as lost provides additional proof that a recovered valuable belongs to the person who reported it missing.

While in the preferred embodiment of the present invention the central registry receives a portion of the reward offered by the owner of the missing article if it is recovered, other financial arrangements may also be used. For example:

The central registry may charge a fixed fee for aiding in the recovery of an article.

The central registry may charge consumers a subscription for using the system.

While in the preferred embodiment of the present invention marking 16 consists solely of the internet address of the central registry it may also include ID-code 12.

While in the preferred embodiment of the present invention data file 28, contains ID-labels 10 inventory form 24 and instructions, data file 28 may only contain ID-labels 10.

While in the preferred embodiment of the present invention the consumer downloads only one file containing ID-labels 10, inventory form 24 and instructions, these may be divided into a plurality of downloadable files.

### SUMMERY, RAMIFICATION, AND SCOPE

Accordingly, the reader will see that the method of use of this invention can be of great value in identifying both personal and corporate possessions as well as for discouraging theft and for verifying ownership. The advantages of the present invention is that valuable, high quality, identification can be offered to the consumer at substantially reduced cost since:

ID-labels or tags do not need to be produced and physically sent to consumers but are downloaded in digital form from a computer network.

the cost of the system is partly funded through advertising by sponsoring companies.

there is no pre-registration of consumers and their valuables.

In the preferred embodiment of the present invention only consumers who actually recover their missing valuables using the system, will incur the cost of the reward that they posted for the return of the valuable.

Although the description above contains many specificity's, these should not be construed as limiting the scope of the invention but as merely providing illustrations of some of the presently preferred embodiments of this invention.

I claim:

1. A method for attaching indicia to personal possessions for lost and found, antitheft and advertising purposes, comprising the steps of:
connecting a computer to a worldwide computer network,
receiving in digital form at least one identification label,
printing said label on paper or other similar sheet material, and
attaching said label to a surface of a personal possession.

2. The method of claim 1 wherein said label is printed with contact information of a central lost and found registry.

3. The method of claim 2 wherein said surface of a personal possession is marked in a substantially indelible way in one or more places with said contact information of said registry using a method selected from the group consisting of engraving with an abrasive, acid etching and inks containing solvents.

4. The method of claim 3 where said contact information is printed using characters consisting of dots which when perforated using a sharp instrument, produce a substantially indelible engraving of said contact information on said surface of the possession.

5. The method of claim 3 wherein said label is printed with a warning that said possession has been marked in a substantially indelible way.

6. The method of claim 1 wherein said label is printed with an identification code.

7. The method of claim 1 where said label is printed with sponsor advertising.

8. The method of claim 1 wherein said label is attached to said surface of a personal possession by covering said label with a piece of transparent adhesive tape which overlaps said label on all sides.

9. The method of claim 1 where said label is printed with notification that a reward will be paid for the return of a missing personal possession to the rightful owner.

10. A system for applying indicia to personal possessions for lost and found, antitheft and advertising purposes, comprising:
at least one host computer which is connected to a worldwide computer network, wherein is stored downloadable identification labels in digital form,
means for connecting one or more remote computers to said host computer to download at least one said label from said host computer to the memory of said remote computer,
means for printing said label on paper or other similar sheet material, while stored in the memory of said remote computer,
a central lost and found registry which stores on a database reports of possessions reported as missing and possessions reported as found, as well as contact information of owners and finders of said possessions.

11. The system of claim 10 wherein said label is printed with contact information of said registry.

12. The system of claim 10 wherein said contact information includes an internet address.

13. The system of claim 10 wherein said surface of a personal possession is marked in a substantially indelible way in one or more places with contact information of said registry.

14. The system of claim 10 wherein said label is printed with an identification code.

15. The system of claim 10 where said label is printed with sponsor advertising.

16. The system of claim 10 wherein said label is affixed to said surface of a personal possession by covering said label with a piece of transparent adhesive tape which overlaps said label on all sides.

17. The system of claim 10 where said means for printing is a printer selected from the group consisting of laser printers, inkjet printers and thermal printers.

18. A method for an owner to recover a lost personal possession which has been marked with contact indicia of a central lost and found registry comprising the steps of:
said owner contacting said registry and filing a description of said lost possession and the owner's contact information,
a finder of said possession contacting said registry and filing a description of said possession as well as the finder's contact information,
said central registry determining a match between the record of said possession's found and lost reports,
said central registry communicating said finder's contact information to said owner so that said possession may be recovered

19. The method of claim 18 where said contact indicia of said registry is printed on a label which was downloaded from a world wide computer network to a remote computer, printed on paper or similar sheet material using a printer and then attached to said possession.

20. The method of claim 18 where said owner only registers said contact information with said central registry when said possession is lost or missing and said owner requires assistance in recovering said possession.
